(19) United States
(12) Patent Application Publication
(10) Pub. No.: US 2010/0301775 A1
(43) Pub. Date: Dec. 2, 2010

(54) Gradual Power Reduction Circuit

(76) Inventor: Gregory L. Bella, (US)

Correspondence Address: Gregory L Bella, 4011 Heron Court, Naperville, IL, 60564, US

(21) Appl. No.: 12/788,431

(22) Filed: May 27, 2010

Related U.S. Application Data
(60) Provisional application No. 61/181,857, filed on May 28, 2009.
(60) Provisional application No. 61/184,802, filed on Jun. 6, 2009.

(51) Int. Cl. H05B 37/02; G05F 1/10

(52) U.S. Cl. 315/307; 323/288

(57) ABSTRACT

Systems and methods to gradually reduce power to a load are disclosed. A method includes initializing a control circuit that is configured to transition from an initial state to a steady state. A first portion of an AC power cycle that is received at the input terminal is selectively blocked from passing to a load terminal. A second portion of the AC power cycle is selectively passed to the load terminal based on an output of the control circuit.

### CROSS-REFERENCE TO RELATED APPLICATIONS

The present application claims the benefit of U.S. Provisional Application No. 61/181,857, filed May 28, 2009, the content of which is incorporated herein by reference in its entirety. The present application also claims the benefit of U.S. Provisional Application No. 61/184,802, filed Jun. 6, 2009, the content of which is incorporated herein by reference in its entirety.

### FIELD OF THE DISCLOSURE

The present disclosure generally related to reducing power to a load.

### BACKGROUND

Electrical devices can operate using alternating current (AC), such as a 60-hertz, 120-volt power signal that is common in the United States. Such devices typically have an “on” setting that provides a return path for the AC signal and an “off” setting that interrupts the return path. Conventional dimmer switches enable users to adjust an amount of power that is provided to a device, such as to control an amount of light provided by a lamp, but such devices typically require a user to re-adjust the dimmer switch when the user wants to change the power level applied to the device. Conventional timing devices enable users to selectively interrupt power to a device based on a clock, an elapsed time, or based on a schedule. However, such timing devices can be expensive and complicated to operate.

### BRIEF DESCRIPTION OF THE DRAWINGS

FIG. 1 is a diagram of a particular embodiment of a system that is operable to gradually reduce power to a load;

FIG. 2 is a diagram of a particular embodiment of a device that is operable to gradually reduce power to a load;

FIG. 3 is a diagram of a particular embodiment of a system that is operable to gradually dim a lamp;

FIG. 4 is a diagram illustrating a reduction of AC power that may be provided by the system of FIG. 1 to a load in response to a change in voltage of a capacitor;

FIG. 5 is a particular embodiment of a circuit diagram that may be used in a system to gradually reduce power to a load; and

FIG. 6 is a circuit diagram of a system to gradually reduce power to a load and that is configurable to operate in a ‘nightlight’ mode.

### DETAILED DESCRIPTION

Systems and methods to gradually decrease power to a load are disclosed. A switching device may provide AC power to a load when a reference voltage exceeds an activation voltage during an AC power signal cycle. After an initialization, an amount of time required for the reference voltage to reach the activation voltage (i.e. an activation delay) increases during each cycle of the AC power signal. As a result, AC power provided to the load is gradually reduced until turning completely off in some implementations, or until reaching a steady-state level in other implementations. The increase in the activation delay may be based on a time constant, such as a time constant for a resistor-capacitor (RC) circuit.

In a particular embodiment, a device includes a circuit that includes a voltage-controlled switching device coupled between an input terminal and a load terminal. The circuit also includes a capacitive element responsive to the input terminal and serially coupled to a current limiting circuit. The voltage-controlled switching device is responsive to a first voltage of the capacitive element. The current limiting circuit includes a capacitor and a current source that is responsive to a second voltage of the capacitor. The current source is configured to provide a current that varies based on the second voltage, A charging rate of the capacitive element changes based on the current.

In another particular embodiment, the device includes a plug configured to couple to an alternating current (AC) power supply and a circuit configured to gradually decrease an amount of power provided to a load device over multiple cycles of the AC power supply. The circuit includes a voltage-controlled switching device coupled between an input terminal and a load terminal, the input terminal coupled to the plug. The circuit also includes a capacitive element responsive to the input terminal and coupled to a current limiting circuit. The voltage-controlled switching device is responsive to a first voltage of the capacitive element. The current limiting circuit includes a capacitor and a current source that is responsive to the capacitor. When AC power is provided to the plug, the circuit gradually decreases the amount of power that is provided to the load device in response to the capacitor charging. When the AC power to the plug is interrupted, the capacitor discharges.

In another particular embodiment, a method includes initializing a control circuit that is configured to transition from an initial state to a steady state. The method also includes selectively blocking a first portion of an AC power cycle that is received at an input terminal from passing to a load terminal and selectively passing a second portion of the AC power cycle to the load terminal based on an output of the control circuit.

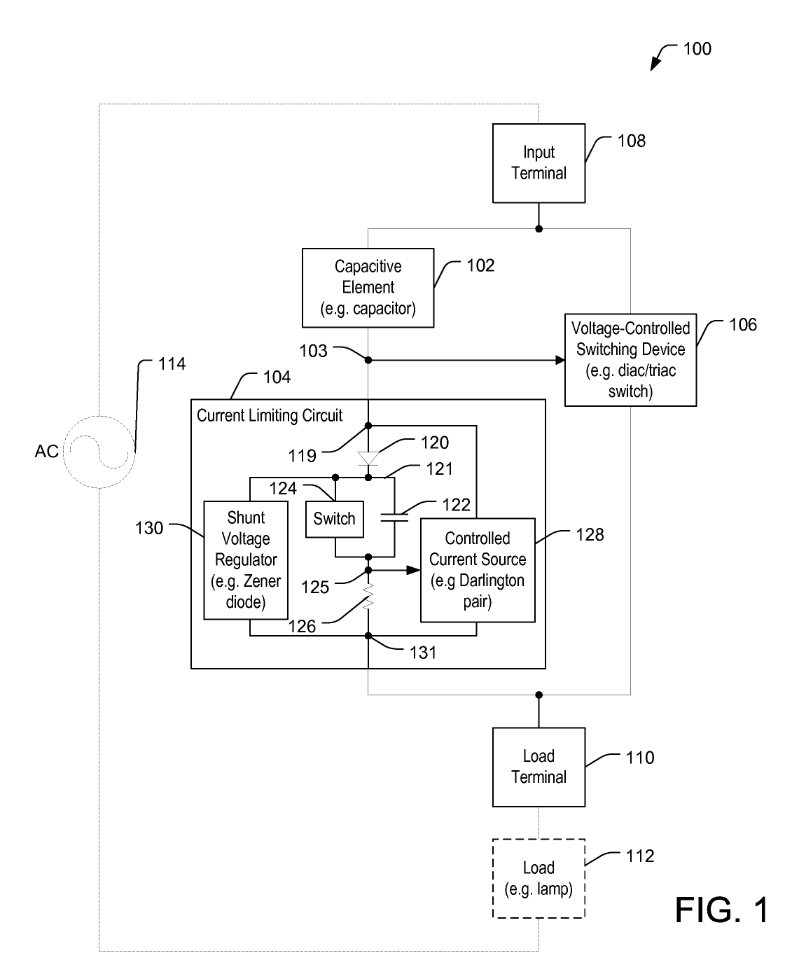

FIG. 1 illustrates a particular embodiment of a system 100 that is operable to gradually reduce power to a load. The system 100 includes a capacitive element 102 coupled to a current limiting circuit 104 via a node 103. A voltage-controlled switching device 106 is coupled to the node 103. The capacitive element 102 and the current limiting circuit 104 are serially coupled between an input terminal 108 and a load terminal 110. In addition, the voltage-controlled switching device 106 is coupled to selectively provide a current path between the input terminal 108 and the load terminal 110. The input terminal 108 is configured to be connected to an alternating current (AC) power supply 114. In addition, the load terminal 110 may be configured to be coupled to a load 112 which in turn is coupled to the AC power supply 114. The voltage-controlled switching device 106 is responsive to a voltage of the node 103, which in turn is responsive to a voltage of the capacitive element 102. The voltage of the capacitive element 102 is controlled by the current limiting circuit 104. As the current limiting circuit 104 gradually decreases an amount of current that is available to charge the capacitive element 102, a voltage at the node 103 during successive cycles of the AC signal 114 gradually decreases, reducing an amount of AC power provided to the load terminal 110 via the voltage-controlled switching device 106, gradually reducing an amount of power received by the load 112 via the load terminal 110.

The capacitive element 102 is coupled between the input terminal 108 and the current limiting circuit 104. For example, the capacitive element 102 may include a capacitor that is responsive to the input terminal 108 and that is serially coupled to the current limiting circuit 104. A charging rate of the capacitive element 102 changes based on the current (e.g. based on changes in the amount of current) that is controlled by the current limiting circuit 104. For example, the charging rate of the capacitive element 102 decreases in response to a reduction of the current supplied by the current limiting circuit 104.

The current limiting circuit 104 includes a capacitor 122 and a current source, such as a controlled current source 128 that is responsive to a voltage of the capacitor 122. The current limiting circuit 104 includes an internal node 119 coupled to an input of the current limiting circuit 104 and an internal node 131 coupled to an output of the current limiting circuit 104. A diode 120 is coupled to enable current flow between the internal node 119 and another internal node 121. A shunt voltage regulator 130 is coupled between the internal node 121 and the node 131. The capacitor 122 and a resistor 126 are coupled at a node 125 and are serially coupled between the node 121 and the node 131. A switch 124 is coupled in parallel to the capacitor 122 between the node 121 and the node 125. The controlled current source 128 is coupled to provide a controlled amount of current between the node 119 and the node 131. The controlled current source 128 is responsive to a voltage at the node 125, which in turn is responsive to the voltage across the capacitor 122.

The diode 120 is configured to control the direction of current between the node 119 and the node 121. Although not illustrated in FIG. 1 for clarity of illustration, a rectifier such as a diode bridge may be included in the current limiting circuit 104 to convert a received alternating current signal to a rectified signal. The voltage at the node 121 is regulated by the shunt voltage regulator 130. For example, the shunt voltage regulator 130 may include a Zener diode. The shunt voltage regulator 130 may be configured to substantially hold a bias at the node 121 at no greater than a pre-determined voltage above a voltage at the node 131. For example, the shunt voltage regulator 130 may include a Zener diode having a breakdown voltage of approximately eleven volts so that substantially no current is allowed to flow through the Zener diode until a voltage across the Zener diode exceeds approximately eleven volts. When a voltage across the Zener diode exceeds the breakdown voltage (e.g. eleven volts), the additional voltage above the breakdown voltage causes a large amount of current to flow through the Zener diode. The large incremental current change in response to an incremental voltage change above the breakdown voltage tends to prevent the voltage from across the Zener diode from substantially exceeding the breakdown voltage. Therefore, an implementation of the shunt voltage regulator 130 using a Zener diode may allow the voltage between the node 121 and the node 131 to vary between zero and eleven volts and may substantially limit the voltage at the node 121 when the voltage at the node 121 begins to exceed eleven volts by enabling current flow through the shunt voltage regulator 130.

A first position of the switch 124 may enable the capacitor 122 to charge and a second position of the switch 124 may enable the capacitor 122 to discharge via a discharge path. For example, the switch 124 may be a push-button switch or a toggle switch. When the switch 124 is closed, the capacitor 122 may charge in response to the voltage between the nodes 121 and 131 exceeding the voltage across the capacitor 122. When the switch 124 opens, the capacitor 122 may be prevented from discharging because of the reverse bias configuration of the diode 120 and the shunt voltage regulator 130 with respect to the capacitor 122. However, when the switch 124 is closed, a path may be established enabling discharge of the capacitor 122. For example, the switch 124 may also include a resistor or other resistive or impedance element to prevent a short circuit across the capacitor 122. The current limiting circuit 104 may also include discharge circuitry (not shown) including a discharge current source to discharge the capacitor 122 when the input terminal 108 is removed or disconnected from the power source.

The capacitor 122 and the resistor 126 are serially connected between the node 121 and the node 131 and form a serial RC circuit. The capacitor 122 may be chosen to have a relatively large capacitance (C), such as approximately 220 microfarads (uF), and the resistor 126 may be chosen to have a relatively large resistance (R), such as approximately 1.65 Megaohm (M). The charging of the capacitor 122 exhibits exponential charging behavior in accordance with a time constant based on a product of R and C (“RC time constant”). With the illustrated values of R and C, the time constant is approximately 363 seconds.

The current limiting circuit 104 may be configured to increase a delay of activating the voltage-controlled switching device 106 during each cycle of an alternating current signal from the AC source 114 while the capacitor 122 charges. The controlled current source 128 is configured to provide a current that varies based on the voltage at the node 125. For example, the controlled current source 128 is responsive to a voltage across the capacitor 122 as the capacitor 122 charges or discharges. The controlled current source 128 may be implemented, for example, as a Darlington pair of bipolar junction transistors (BJTs).

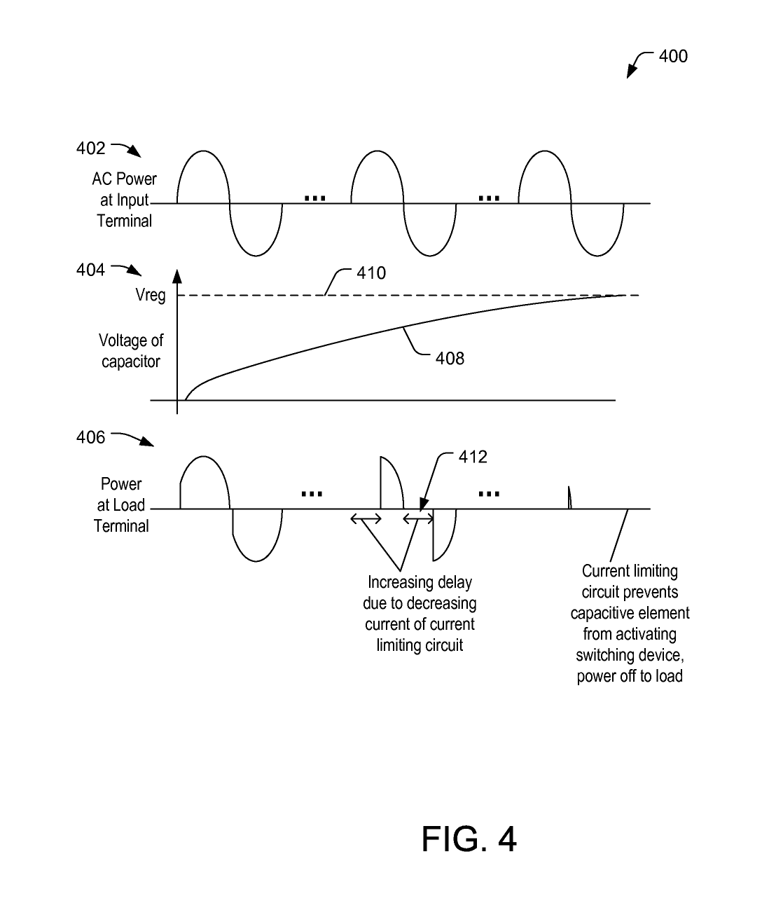

The voltage-controlled switching device 106 is responsive to a voltage at the node 103 to selectively enable current flow between the input terminal 108 and the load terminal 110 through the switching device 106. For example, the switching device 106 may include a diac coupled to a gate of a triac to operate as a voltage controlled switch. When the voltage at the node 103 exceeds a voltage of the load terminal 110 by more than a threshold amount, the voltage controlled switching device 106 may turn on and enable current flow between the input terminal 108 and the load terminal 110. When the voltage at the node 103 does not exceed the voltage of the load terminal 110 by more than the threshold amount, the voltage controlled switching device 106 may be off, and substantially zero current may flow through the voltage controlled switching device 106. When the capacitor 122 is gradually charging from an initial discharged condition, and as a result an amount of charging current that is available via the current limiting circuit 104 is gradually decreasing, power provided via the load terminal 110 to the load 122 also decreases in response to the increase in the delay of activating the voltage-controlled switching device 106, as illustrated in FIG. 4.

During operation, the load terminal 110 may be coupled to the AC power supply 114 and the load 112 may be coupled between the load terminal 110 and the AC power supply 114. As a received AC signal at the input terminal 108 increases in voltage, the capacitive element 102 begins to charge according to a voltage difference between the input terminal 108 and the load terminal 110. However, the charging current of the capacitive element 102 is limited by the current limiting circuit 104. When the capacitor 122 of the current limiting circuit 104 is discharged, an initial amount of current is allowed to flow through the current limiting circuit 104 in response to the internal node 125 having substantially the same voltage as the internal node 121. The initial discharged state of the capacitor 122 provides a largest amount of current from the controlled current source 128 based on the voltage at the node 125.

When the capacitive element 102 charges to a sufficient amount to activate (i.e. to transition from providing a high impedance between the input terminal 108 and the load terminal 110 to providing a low impedance between the input terminal 108 and the load terminal 110) the voltage-controlled switching device 106, the voltage-controlled switching device 106 allows the AC signal to be applied to the load terminal 110. As the voltage at the input terminal 108 returns to zero at a half cycle of the AC signal and becomes increasingly negative, a rectifier within the current limiting circuit 104 (not shown) may enable similar operation as during the positive half-cycle, preventing application of the AC signal to the load terminal 110 until a first voltage across the capacitive element 102 exceeds a threshold of the voltage-controlled switching device 106, at which point the voltage-controlled switching device 106 activates and applies the AC signal to the load terminal 110.

A charging rate of the capacitive element 102 and a corresponding voltage (first voltage) across the capacitive element 102 changes based on the charging current, and the charging current varies based on a voltage across the capacitor 122 (second voltage). The current source 128 is configured to reduce the current in response to an increase of the second voltage, and a charging rate of the capacitive element 102 decreases in response to a reduction of the current from the current source 128. As an AC signal remains applied to the input terminal 108 after an initial discharge of the capacitor 122, the capacitor 122 slowly charges, according to the RC time constant. As the capacitor 122 charges, the voltage at the internal node 125 reduces. In response to the voltage at the internal node 125 being reduced, an amount of current provided by the controlled current source 128 is gradually reduced, which in turn gradually reduces the amount of charging current for the capacitive element 102. A reduction in the amount of charging current for the capacitive element 102 results in an increasing delay from an application of a non-zero signal at the input terminal 108 (e.g. after an AC signal applied to the input terminal 108 crosses a zero voltage level) until activation of the voltage controlled switching device 106.

As a result, an amount of power received at the load 112 via the load terminal 110 may initially substantially approximate a signal provided by the AC power supply 114 and is gradually reduced as an initial phase delay is introduced by the voltage-controlled switching device 106 at each zero-voltage crossing of the AC signal. Eventually, the capacitive element 102 may not receive enough charging current to enable sufficient voltage across the capacitive element 102 to cause the voltage at the node 103 to activate the voltage-controlled switching device 106 through the entire AC signal cycle. At this point in time, no further power is applied to the load 112.

Therefore, after the switch 124 is opened, power provided to the load 112 starts at a high level and gradually decreases over multiple cycles of the AC signal until the power is completely cut off. When the load 112 includes a light source coupled to the load terminal 110 and the switch 124 is set into the first position while the system 100 is coupled to the alternating power supply 114, light that is provided by the light source gradually dims over multiple cycles of AC power supply until the light source turns off when power is no longer received. A rate of the dimming may be controlled by adjusting a value of the capacitance C of the capacitor 122, the resistance R of the resistor 126, or both.

Although the system 100 is illustrated as including capacitive elements and controlling operation based on voltages of the capacitive elements, in other implementations one or more capacitive components may be replaced with inductive components or other arrangements that result in circuitry to gradually decrease an amount of current of the controlled current source 128. For example, the capacitor 122 and resistor 126 arrangement resulting in the RC time constant may instead be implemented using at least one component with an inductance L that controls the current source 128 according to an L/R time constant. In other implementations, control signals provided by other circuit arrangements to gradually decrease the amount of current of the controlled current source 128 may have other time constants or may exhibit non-exponential behavior, such as a linear control signal, a damped (e.g. over-damped) oscillatory control signal, a piece-wise continuous control signal, another type of control signal, or any combination thereof.

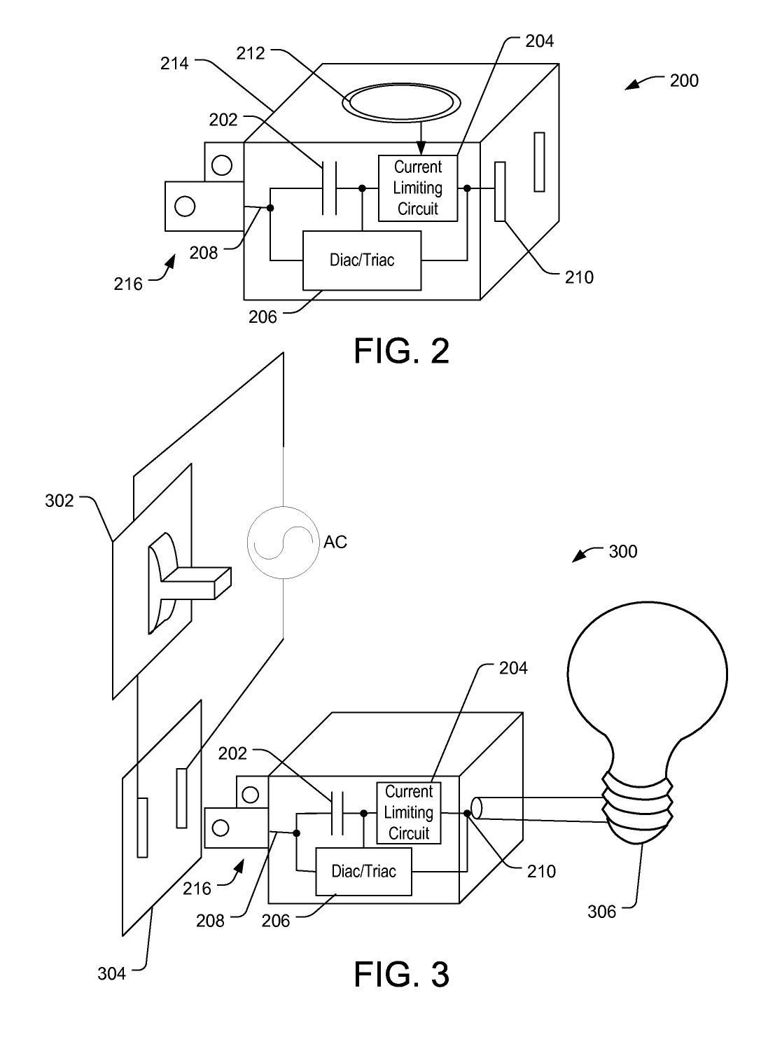

Referring to FIG. 2, a particular embodiment of a device including a current limiting circuit is depicted and generally designated 200. The device 200 includes a capacitor 202 serially coupled to a current limiting circuit 204 between an input terminal 208 and a load terminal 210. A diac/triac pair 206 is coupled between the input terminal 208 and the load terminal 210 to selectively couple or decouple the input terminal 208 to the load terminal 210. Elements of the device 200 may be similar to elements of FIG. 1. For example, the input terminal 208 may correspond to the input terminal 108, the capacitor 202 may correspond to the capacitive element 102, the current limiting circuit 204 may correspond to the current limiting circuit 104, the diac/triac 206 may correspond to the voltage-controlled switching device 106, and the load terminal 210 may correspond to the load terminal 110 of FIG. 1. The device 200 may be an inline-type of electrical device that includes a housing 214 and a plug 216. The circuitry, including the capacitor 202, the current limiting circuit 204, and the diac/triac 206, is at least partially enclosed within the housing 214. The plug 216 is configured to couple to an AC power supply and the input terminal 208 is coupled to the plug 216. The device 200 may also include a switch 212 that is accessible at an exterior of the housing 214.

During operation, the device 200 may be coupled to an AC power supply, such as by inserting the plug 216 of the device 200 into a wall outlet, and a load device may be coupled to the device 200, such as via a plug being inserted into a receptacle coupled to the load terminal 210. When AC power is provided to the plug 216, the circuitry may gradually decrease the amount of power that is provided to the load device in response to a capacitor charging, such as the capacitor 122 of FIG. 1, and when the AC power to the plug 216 is interrupted, the capacitor discharges. Activation of the push-button 212 (or other toggle or switching mechanism) may cause a switch to discharge a capacitor within the current limiting circuit 204, such as the switch 124 of FIG. 1. After activation of the push-button 212, AC power may be provided to the load terminal 210 in a gradually decreasing amount until power to the load is either turned off or maintained at a small steady-state amount supplied to a load device.

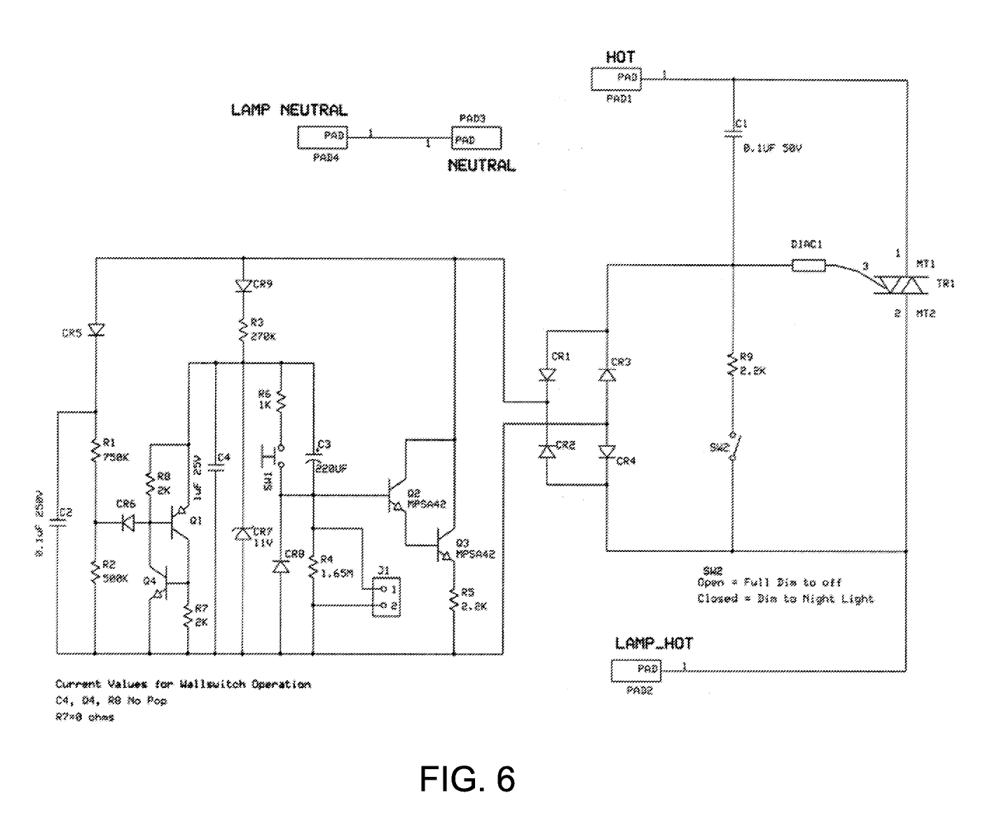

The device 200 may be used to gradually reduce power that is applied to a load. For example, the device 200 may be used to couple a lamp to an AC power supply and may operate as a gradual dimmer switch that can be activated by pressing the button 212. After pressing the button 212, the light provided by the lamp coupled to the device 200 will gradually dim until eventually either turning off or being maintained in a nightlight mode receiving a small steady-state amount of power, as described with respect to FIG. 6. The device 200 may be reset by pressing the button 212, resulting in the lamp returning to an initial bright state and gradually dimming over time to the steady nightlight state or turning off. As compared to conventional digital or mechanical timing devices, the device 200 may be manufactured using inexpensive components and may provide a simpler and more intuitive user interface for operation (e.g. a single button 212).

FIG. 3 illustrates a system 300 that includes a device having the input terminal 208, the capacitor 202, the current limiting circuit 204, the diac/triac 206, and the output terminal 210 of FIG. 2. The output terminal 210 is illustrated as attached to a lamp 306, such as via an AC power cord. The input terminal 208 is shown as being coupled to the plug 216 that is configured to couple to an AC power supply via a receptacle 304 such as a wall outlet. The receptacle 304 may be controlled by a switch 302, illustrated as a wall-mounted switch, which may be configured to selectively interrupt AC power provided to the receptacle 304. When the input terminal 208 is coupled to the receptacle 304 and the switch 302 is turned on, the current limiting circuit 204 may be set to an initial state to provide a largest amount of AC power to the lamp 306, and may gradually decrease an amount of charging current provided to the capacitor 202. Decreasing charging current to the capacitor 202 increases an activation delay of diac/triac 206 during the AC signal cycle, gradually reducing the power to the lamp 306 until the lamp 306 eventually turns off or maintains operation in a nightlight mode.

Upon turning the switch 302 to an off position, the current limiting circuit 204 may reset by discharging an internal capacitor, such as the internal capacitor 122 illustrated in FIG. 1. Discharging the internal capacitor enables reactivation of the gradual dimming operation upon subsequent turn on of the wall switch 302.

A gradual dimming operation of the lamp 306 may therefore be conveniently controlled via the switch 302. When the switch 302 remains in an “off” position, the lamp 306 may remain off. When the switch 302 is set to an “on” position, the lamp 306 turns on to produce a substantially full-power illumination that gradually dims over time. Operation of the lamp 306 may therefore be controlled in a convenient and intuitive manner, such as by using a wall switch.

FIG. 4 illustrates a simplified example 400 of operation of the system 100 of FIG. 1 and also illustrates operation of the devices of FIGS. 2-3. A first trace 402 illustrates AC power received at the input terminal 108 of FIG. 1. The AC signal 402 is shown as multiple cycles of a sinusoid signal with each cycle having a voltage that increases from a zero amount to a largest amount, decreases across zero volts to a lowest negative amount, and returns to a zero amount. A length of time to transition from the initial zero amount to the ending zero amount after the intermediate zero crossing is referred to as a period of the AC signal 402.

A voltage characteristic 404 shows a voltage 408 of the internal capacitor 122 within the current limiting circuit 104. The voltage 408 begins at zero, indicating that the capacitor 122 may initially be in a discharged state having substantially zero volts when the AC power is applied. As time elapses after application of the AC signal 402, the voltage 408 gradually increases in accordance with the RC time constant. Eventually the voltage 408 approaches the voltage 410 regulated by the shunt voltage regulator 130. When the voltage 408 of the capacitor 122 approximately equals the regulated voltage 410, the input voltage at the internal node 125 to the controlled current source 128 may be approximately the same as the voltage at the internal node 131, resulting in a smallest current through the controlled current source 128 or the controlled current source 128 being off.

A power signal 406 at the load terminal 110 is illustrated as approximately following the AC power signal 402, with an initial delay before rising from a zero point to a positive voltage. The initial delay is a result of the voltage-controlled switching device 106 initially being in an off position and not turning on until the voltage at the node 103 exceeds a threshold amount, based on the voltage across the capacitive element 102. When the voltage 408 of the capacitor 122 is initially zero, a largest charging current is available through the current limiting circuit 104, resulting in a fastest charge of the capacitive element 102 and a quickest turn on of the voltage controlled switching device 106.

As time elapses and the capacitor voltage 408 increases, there is an increasing delay 412 of application of the AC signal 402 to the load terminal 110 due to the decreasing current of the current limiting circuit 104. The current of the current limiting circuit 104 decreases in response to the voltage at the node 125 gradually decreasing from the voltage of the node 121 to the voltage of the node 131 as the voltage 408 across the capacitor 122 gradually increases. The reduced voltage of the internal node 125 reduces the amount of current provided by the controlled current source 128, decreasing an amount of charging current available to the capacitive element 102.

The decreased amount of charging current available to the capacitive element 102 increases a delay of the capacitive element 102 to increase the voltage at the internal node 103 above the threshold voltage to activate the voltage controlled switching current 106. As illustrated, when the capacitor voltage 408 approximately equals the regulated voltage 410, representing the regulated voltage difference between the node 121 and the node 131, the controlled current source 128 restricts an amount of charging current through the current limiting circuit 104. When the charging current is sufficiently limited, the capacitive element 102 no longer has sufficient time during an AC cycle to charge above the activation threshold of the voltage-controlled switching device 106, at which point AC power is no longer provided to the load terminal 110.

FIG. 4 therefore illustrates that, after initializing a control circuit that is configured to transition from an initial state to a steady state according to a time constant, such as by an initial discharging of the capacitor 122 that charges according to an RC time constant, a first portion of an AC power cycle that is received at an input terminal 108 is selectively blocked from passing to the load terminal 110 (during the delay time period 412). A second portion of the AC power cycle (following the delay 412) is selectively passed to the load terminal 110 based on an output of the control circuit. The time constant is longer than a period of the AC power cycle and may be set using values of a capacitor and/or a resistor in the control circuit (and/or L in implementations that include an inductive element). For example, using a capacitance (C) of 220 uF and a resistance (R) of 1.65 M, the time constant may be approximately 363 seconds.

The first portion of the AC power cycle during the delay time period 412 (i.e. the portion of the AC power cycle that is blocked from the load) increases and the second portion of the AC power cycle following the delay 412 (i.e. the portion of the AC power cycle that is applied to the load) decreases as the control circuit transitions from the initial state to the steady state. For example, the steady state may include no power being received at the load terminal 110. As another example, the steady state may include “nightlight” operation where the delay 412 stops increasing before reaching a full half-cycle of the AC signal, as described with respect to FIG. 6.

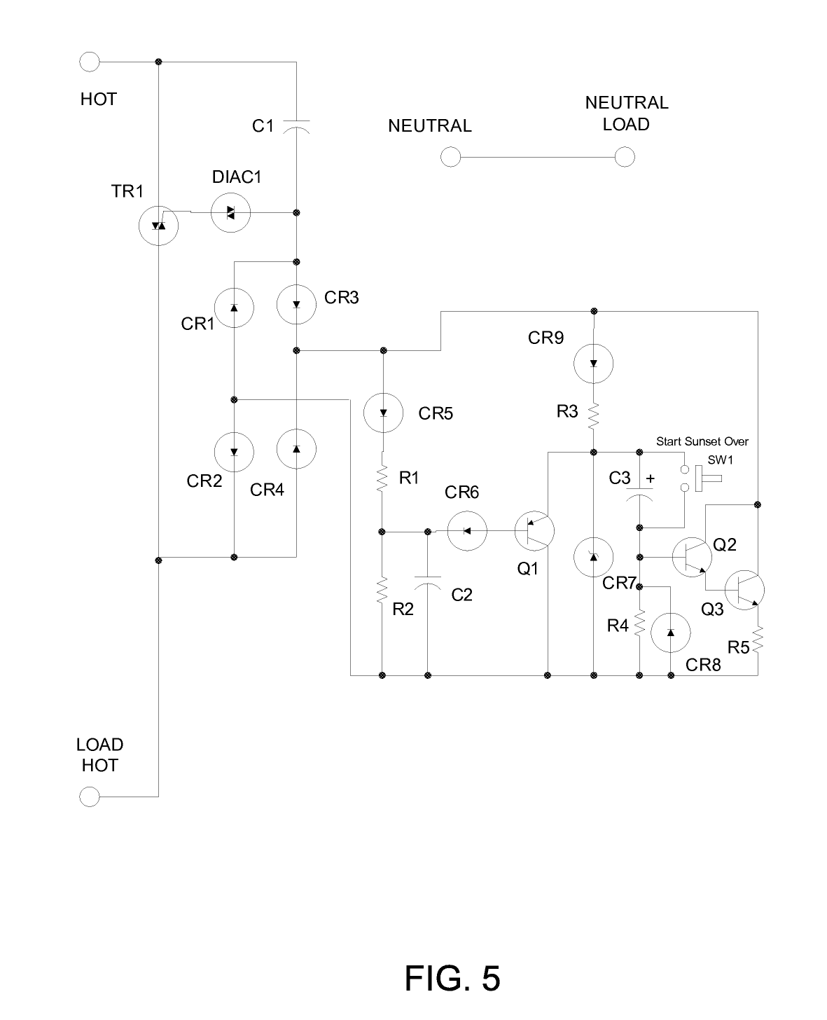

FIG. 5 illustrates a particular example of a circuit that may be used to control an amount of current provided to a load device via a load terminal. The circuit of FIG. 5 illustrates an input terminal labeled Hot and a load terminal labeled Load Hot. A triac TR1 is coupled between the Hot terminal and the Load Hot terminal. A diac labeled DIAC1 is coupled to a gate of the triac. A capacitor labeled C1 is coupled to the Hot terminal and to an input to the diac DIAC1. A diode bridge is coupled between the input to the DIAC1 and the Load Hot terminal. The diode bridge includes diodes CR1, CR2, CR3, and CR4, configured to rectify a signal provided to a current limiting circuit so that a current flows into a first node (between CR3 and CR4) and out of a second node (between CR1 and CR2). In a particular embodiment, the capacitor Cl may correspond to the capacitive element 102 of FIG. 1, DIAC1 and TRIAC1 may correspond to the voltage controlled switching device 106, the Hot terminal may corresponds to the input terminal 108, and the Load Hot terminal may correspond to the load terminal 110, illustrated in FIG. 1.

The current limiting circuit is coupled to the diode bridge and includes a first diode CR5, a first resistor R1, and a second resistor R2 serially coupled between the first node and the second node of the diode bridge. A capacitor C2 is coupled to a node between R1 and R2, and a diode CR6 is coupled to the capacitor and to a base of a transistor Q1, illustrated as a bi-polar junction transistor (BJT). A diode CR9 is coupled to the diode CR5 and is configured to enable current flow to a resistor R3. The resistor R3 is coupled to an emitter of the transistor Q1. The resistor R3 is also coupled to a Zener diode CR7, to a capacitor C3, and to a switch SW1. The capacitor C3 and the switch SW1 are connected in parallel and are each coupled to a base of a transistor Q2, and to a resistor R4 and a diode CR8 that are coupled in parallel.

The transistor Q2 has a collector that is coupled to an input of the diode CR9 and has an emitter that is coupled to a base of the transistor Q3 in a Darlington configuration. The collector of the transistor Q3 is coupled to the input of the diode CR9 and an emitter of the transistor Q3 is coupled to a resistor R5. The resistor R5, the diode CR8, the resistor R4, the Zener diode CR7, the collector of the transistor Q1, the capacitor C2, and the resistor R2 are all coupled to the second node of the diode bridge.

Components of FIG. 5 may be similar to or correspond to components of FIG. 1. For example, the diode CR9 may correspond to the diode 120, the switch SW1 may correspond to the switch 124, the capacitor C3 may correspond to the capacitor 122, the transistors Q2, Q3, and the resistor R5 may correspond to the controlled current source 128, and the resistor R4 and the diode CR8 may correspond to the resistor 126 of FIG. 1. The Zener diode CR7 may correspond to the shunt voltage regulator 130 of FIG. 1. In addition, the transistor Q1, the diode CR6, the transistor C2, the diode CR5, the resistor R1, and the resistor R2 are configured as discharge circuitry including a discharge current source (Q1) to discharge the capacitor C3 when the Hot terminal is removed from a power source.

Refer to FIG. 5. CR5, R1, R2, C2, CR6, Q1 and CR8 make up the automatic discharge circuit. The purpose of this circuit is to quickly discharge C3 when the wall switch is turned to the off position. This circuit enables wallswitch operation as a means to restart the dimming cycle. When the wallswitch is in the on position, R1, R2 and C2 keeps the voltage at CR6 high enough to keep the transistor Q1 off thereby allowing C3 to gradually charge and in response gradually decrease the power to the load thereby causing gradual automatic dimming. When the wallswitch is turned to the off position, capacitor C2 discharges via R2 thereby causing Q1 to turn on and discharge C3 through the diode CR8 and the transistor. When the wallswitch is turned back to the on position, C3 will be discharged thereby causing full power to be delivered to the lamp and therefore restarting the dimming cycle. CR9, R3, CR7,C3,R4,C3,Q2,Q3 and R5 make up the current limiting circuit. Initially the voltage across C3 is 0 volts. If for example the zener CR7 is 11V, then the voltage at the base of Q2 is 11 volts and therefore the current source is at its maximum current of (11V−2VBE)/R5. As time goes by, the voltage across C3 increases thereby decreasing the voltage at the base of Q2 consequently decreasing the current. When the current source is at its maximum current, C1 will quickly charge as the AC voltage increases. When the voltage across C1 approaches the diac's breakover voltage, DIAC 1 will conduct and therefore turn on TR1 thereby deliver AC current to the lamp load. As the current source decreases the magnitude of the current flow, it takes longer for C1 to charge up to the Diacs trigger voltage thereby triggering the triac TR1 further into the half wave of the sinewave which decreases power to the load. Eventually the current source is low enough so that C1 never reaches the diac's trigger voltage whereby the lamp will remain off.

FIG. 6 depicts another implementation and has a Hot terminal and Lamp_Hot terminal. A triac TR1 is coupled between the Hot terminal and the Lamp_Hot terminal. A gate of the triac TR1 is coupled to an output of a diac DIAC1 and an input of the diac DIAC1 is coupled between a capacitor C1 and a resistor R9. The capacitor C1, the resistor R9 and a switch SW2 are serially coupled between the Hot terminal and the Lamp_Hot terminal. A diode bridge includes diodes CR1, CR2, CR3, and CR4 and is coupled to the capacitor C1 and to the Lamp_Hot terminal to rectify a signal to a current limiting circuit.

The current limiting circuit includes a voltage-controlled current source including a Darlington pair of transistors Q2 and Q3 and also including a resistor R5 between a first node and a second node of the diode bridge. A diode CR9 is coupled to the first node and has an output that is provided to a resistor R3. A capacitor C3 is coupled between the resistor R3 and the base of the transistor Q2. A resistor R6 and a switch SW1 are serially coupled between the resistor R3 and the base of the transistor Q2. A reverse biased diode CR8 is coupled between the base of the transistor Q2 and the second node. A resistor R4 is coupled between the base of the transistor Q2 and the second node. A Zener diode CR7, illustrated as an eleven volt diode, is coupled between the resistor R3 and second node. A capacitor C4 is coupled between the resistor R3 and the second node.

A discharge circuit includes the capacitor C4 coupled in parallel with a discharge current source that includes transistors Q1 and Q4 and resistors R7 and R8. The resistor R8 is coupled between an emitter of the transistor Q1 and a base of the transistor Q1. The transistor Q4 has a collector coupled to the base of the transistor Q1 and a base coupled to the collector of the transistor Q1 and to the resistor R7. A diode CR6 has an input coupled to the base of the transistor Q1 and having an output coupled to a node within a voltage divider formed by resistors R1 and R2 serially coupled between an output of a diode CR5 and the second node. A capacitor C2 is coupled across the pair of resistors R1 and R2.

In addition, a junction J1 is illustrated as providing a means to quickly functionally test the circuit prior to shipping. A small value resistor can be connected across J1 so as to change the time constant so as to verify the gradual dimming over a much shorter time frame.

The circuit of FIG. 6 can operate in a “nightlight” mode that maintains a small, steady-state power level applied to the Lamp_Hot terminal after the capacitor C3 of the current limiting circuit has fully charged. The resistor R9 is a resistive element coupled between the capacitor Cl and the Lamp_Hot terminal to provide a bypass current path that bypasses the current limiting circuit to enable the capacitor C1 to charge a sufficient amount to activate the triac TR1 during each AC cycle. R9 may have a value selected to control how late in the AC cycle the triac TR1 activates and thus to control an amount of power provided to the Lamp_Hot terminal in the nightlight mode. The switch SW2 may be included as a bypass switch configured to selectively interrupt the bypass current path, enabling selection of operation in nightlight mode or a mode where the triac TR1 eventually stops activating.

FIG. 6 is very similar to FIG. 5 with the exception of the night light circuit made up of R9 and SW2 and a modified wallswitch operation circuit that replaces the single transistor discharge circuit to an SCR type latched 2 transistor circuit made up of Q1 and Q4 in addition to R7 and R8. When the wallswitch is turned to the off position, C2 will discharge via R1 and R2 until eventually Q1 turns on which in turn turns on Q4 which in turn turns on Q1 harder. This circuit latches on until the current through the transistors decreases to VBE/R7 or VBE/R8.

The illustrations of the embodiments described herein are intended to provide a general understanding of the various embodiments. Other embodiments may be utilized and derived from the disclosure, such that structural and logical substitutions and changes may be made without departing from the scope of the disclosure. This disclosure is intended to cover any and all subsequent adaptations or variations of various embodiments. Accordingly, the disclosure and the figures are to be regarded as illustrative rather than restrictive.

The above-disclosed subject matter is to be considered illustrative, and not restrictive, and the appended claims are intended to cover all such modifications, enhancements, and other embodiments, which fall within the scope of the present disclosure. Thus, to the maximum extent allowed by law, the scope of the present invention is to be determined by the broadest permissible interpretation of the following claims and their equivalents, and shall not be restricted or limited by the foregoing detailed description.

What is claimed is:

1. A device comprising:
a circuit comprising:
a voltage-controlled switching device coupled between an input terminal and a load terminal; and
a capacitive element responsive to the input terminal and serially coupled to a current limiting circuit,
wherein the voltage-controlled switching device is responsive to a first voltage of the capacitive element,
wherein the current limiting circuit includes a capacitor and a current source that is responsive to a second voltage of the capacitor,
wherein the current source is configured to provide a current that varies based on the second voltage,
and wherein a charging rate of the capacitive element changes based on the current.

2. The device of claim 1, wherein the current source is configured to reduce the current in response to an increase of the second voltage, and wherein the charging rate of the capacitive element decreases in response to a reduction of the current.

3. The device of claim 1, wherein:
the current limiting circuit is configured to increase a delay of activating the voltage-controlled switching device during each cycle of an alternating current signal while the capacitor charges, and
power provided via the load terminal to a load decreases in response to the increase of the delay of activating the voltage-controlled switching device.

4. The device of claim 1, wherein:
the current limiting circuit further comprises a switch coupled to the capacitor, and
a first position of the switch enables the capacitor to charge and wherein a second position of the switch enables the capacitor to discharge via a discharge path.

5. The device of claim 4, wherein the current limiting circuit further comprises discharge circuitry including a discharge current source to discharge the capacitor when the input terminal is removed from a power source.

6. The device of claim 4, wherein the circuit is at least partially enclosed within a housing, and wherein the switch is accessible at an exterior of the housing.

7. The device of claim 4, further comprising a light source coupled to the load terminal, wherein in response to the switch being set into the first position while the device is coupled to an alternating current (AC) power supply, light provided by the light source gradually dims over multiple cycles of the AC power supply.

8. The device of claim 1, wherein:
the capacitive element is coupled between the input terminal and a first node;
the voltage-controlled switching device comprises a triac coupled between the input terminal and the load terminal and a diac coupled between the first node and a gate of the triac;
the current limiting circuit is coupled between the first node and the load terminal via a diode bridge;
the current limiting circuit comprises the current source, the capacitor, a switch coupled to the capacitor, and a shunt voltage regulator;
the capacitor and a resistor are serially coupled between a second node and a third node;
the current source includes a darlington pair of bipolar junction transistors coupled between the second node and the third node, wherein a base of the darlington pair is coupled to a fourth node between the capacitor and the resistor;
the shunt voltage regulator is coupled between the second node and the third node; and
the switch is configured to selectively open or close a discharge path of the capacitor.

9. The device of claim 1, further comprising a resistive element coupled between the capacitive element and the load terminal to provide a bypass current path that bypasses the current limiting circuit.

10. The device of claim 9, further comprising a bypass switch configured to selectively interrupt the bypass current path.

11. A device comprising:
a plug configured to couple to an alternating current (AC) power supply;
a circuit configured to gradually decrease an amount of power provided to a load device over multiple cycles of the AC power supply, the circuit comprising:
a voltage-controlled switching device coupled between an input terminal and a load terminal, the input terminal coupled to the plug; and
a capacitive element responsive to the input terminal and coupled to a current limiting circuit,
wherein the voltage-controlled switching device is responsive to a first voltage of the capacitive element,
wherein the current limiting circuit includes a capacitor and a current source that is responsive to a second voltage of the capacitor;
wherein, when AC power is provided to the plug, the circuit gradually decreases the amount of power that is provided to the load device in response to the capacitor charging; and
wherein, when the AC power to the plug is interrupted, the capacitor discharges.

12. The device of claim 11, wherein the plug is configured to couple to the AC power supply via a receptacle controlled by a wall switch to selectively interrupt the AC power.

13. The device of claim 11, wherein the current limiting circuit is responsive to an increase of the second voltage of the capacitor to decrease a charging current to the capacitive element.

14. The device of claim 13, wherein decreasing the charging current to the capacitive element increases a delay of activating the voltage-controlled switching device during each cycle of an alternating current signal while the capacitor charges.

15. The device of claim 14, wherein the amount of power provided to the load decreases in response to the increase of the delay of activating the voltage-controlled switching device.

16. The device of claim 11, wherein the current limiting circuit further comprises a switch coupled to the capacitor, wherein a first position of the switch enables the capacitor to charge and wherein a second position of the switch enables the capacitor to discharge.

17. The device of claim 11, further comprising a bypass switch coupled between the capacitive element and the load terminal to selectively provide a bypass current path that bypasses the current limiting circuit.

18. A method comprising:
initializing a control circuit that is configured to transition from an initial state to a steady state according to a time constant; and
selectively blocking a first portion of an AC power cycle that is received at an input terminal from passing to a load terminal and selectively passing a second portion of the AC power cycle to the load terminal based on an output of the control circuit,
wherein the time constant is longer than a period of the AC power cycle.

19. The method of claim 18, wherein the first portion increases as the control circuit transitions from the initial state to the steady state.

20. The method of claim 18, wherein the control circuit includes a capacitor and a resistor.
